(19) United States
(12) Patent Application Publication
(10) Pub. No.: US 2010/0086792 A1
(43) Pub. Date: Apr. 8, 2010

(54) POLYIMIDE PRECURSOR, ITS COMPOSITION AND POLYIMIDE LAMINATE

(75) Inventors: Shun-Jen Chiang, Yong-Kang City (TW); Chung-Jen Wu, Tainan City (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: ETERNAL CHEMICAL CO., LTD., Kaohsiung (TW)

(21) Appl. No.: 12/437,293

(22) Filed: May 7, 2009

(30) Foreign Application Priority Data
Oct. 3, 2008 (TW) 097138205

(51) Int. Cl. B32B 15/08; C08G 69/00

(52) U.S. Cl. 428/458; 528/348

(57) ABSTRACT

A polyimide precursor and its composition as well as a polyimide laminate are provided. The polyimide precursor and its composition are prepared using a diamine monomer and a dianhydride monomer in a specific composition proportion. The composition is coated on a copper foil and then cured to provide a polyimide laminate with a desired Coefficient of Thermal Expansion (CTE) and exhibiting desired properties, such as film flatness, dimensional stability, peeling strength, tensile strength, and elongation.

This application claims priority to Taiwan Patent Application No. 097138205 filed on Oct. 3, 2008.

### CROSS-REFERENCES TO RELATED APPLICATIONS

Not applicable.

### FIELD OF THE INVENTION

The present invention provides a polyimide precursor and its composition with a coefficient of thermal expansion close to that of copper foil. The polyimide precursor and its composition are suitable for manufacturing a polyimide copper clad laminate, in particular for producing a flexible printed circuit board.

### BACKGROUND OF THE INVENTION

Polyimide polymers have excellent thermal stability, and currently have been widely used as electronic materials, in particular for products using flexible printed circuit boards such as consumer electronic products (e.g.: notebook computers, mobile phones, and digital cameras). Because electronic products have been developed to be increasingly smaller, lighter and thinner, the development of a flexible printed circuit board substrate must correspondingly move towards a lighter, thinner and adhesiveless polyimide copper clad laminate for the demand for convenience in life.

Due to the weak adhesion between an ordinary polyimide and copper foil, the conventional polyimide copper clad laminate requires the aid of an adhesive for binding the polyimide film and copper foil. However, since the heat resistance of the adhesive is poor, the use of the laminate is restricted by the temperature. In addition, the production process of the laminate is relatively complicated. To simplify the process and reduce the costs, the polyimide film can be directly bound to a copper foil to prepare an adhesiveless polyimide copper clad laminate. Using such a manner, the heat and weather resistances of the copper clad laminate are increased because there is no need for a poor heat resistant adhesive.

The adhesiveless polyimide copper clad laminate is prepared with a polyamic acid as the precursor. For example, an aromatic dianhydride monomer and an aromatic diamine monomer are reacted in a polar aprotic solvent to prepare a polyamic acid solution. Then, the resulting polyamic acid solution is coated onto the surface of a copper foil and heated to remove the solvent contained therein, followed by imidization of the polyamic acid at high temperature to form a polyimide film on the surface of the copper foil.

Since the circuit board will pass through many slot channels of the apparatus in the course of producing a flexible printed circuit board, the circuit board with warping phenomenon may cause the interruption of the entire process because it cannot smoothly pass through the slot channels of the apparatus. Therefore, in the course of producing a flexible printed circuit board, either the initial copper clad laminate or the flexible printed circuit board that has been subjected to an etching procedure must maintain flat. However, with the thinner adhesiveless polyimide flexible printed circuit board, curling may occur even though only a little stress remains. The major cause of the curling lies in the difference of the coefficient of thermal expansion between the polyimide film and the copper foil of the flexible printed circuit board. Particularly, after the etching process, the stress formed between the polyimide film and the copper foil becomes more significant. The warping phenomenon mentioned above also reflects the dimensional stability of the flexible printed circuit board.

Furthermore, because the circuit designs and processes of a flexible printed circuit board are gradually miniaturized, it is important to maintain the dimensional stability of a polyimide flexible printed circuit board, in particular for the via hole alignment of a flexible printed circuit board. If the dimensional stability of the flexible printed circuit board is poor, the via holes may be damaged due to a higher thermal stress generated in the process. If the circuit board has better dimensional stability, it can be manufactured to a flatter polyimide flexible printed circuit board. Meanwhile, curling does not appear after the etching process, and thus, all requirements for the processes of manufacturing a flexible printed circuit board can be satisfied.

Because the adhesiveless polyimide copper clad laminate has no adhesive, both of its high temperature resistance and mechanical property can meet the requirements. To obtain a substrate with good flatness, the polyimide polymers should have a coefficient of thermal expansion close to that of the copper foil. Therefore, it is necessary that an appropriate monomer combination is selected to synthesize the polyimide polymers. However, it is known from the prior art that the polyimide film with good flatness and dimensional stability generally does not have good peeling strength, with respect to the adhesion between the polyimide and the copper foil.

It is known from above that a polyimide copper clad laminate, which not only has a coefficient of thermal expansion close to that of copper foil as well as good dimensional stability but also exhibits excellent adhesion, has been greatly desired in this field.

### SUMMARY OF THE INVENTION

One objective of the present invention is to provide a polyimide precursor that is obtained by the polymerization of a diamine monomer and a dianhydride monomer, wherein the diamine monomer comprises at least one compound of formula (I) and at least one compound of formula (II):

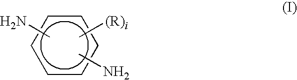

wherein each R independently represents hydrogen, halogen, —CₐH₂ₐ₊₁ or —C_{b}F_{2b+1}, wherein each of a and b is independently 1, 2, 3 or 4; and i is 1, 2, 3 or 4;

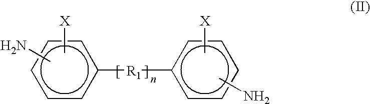

wherein n is 0 or 1, each R₁ independently represents —CH₂—, —O—, —S—, —CO—, —SO₂—, —C(CH₃)₂— or —C(CF₃)₂—, and each X independently represents hydrogen, halogen, —OH, —COOH, —CₐH₂ₐ₊₁ or —C_{b}F_{2b+1}, wherein each of a and b is independently 1, 2, 3 or 4;
the dianhydride monomer comprises at least one compound of formula (III) and at least one compound of formula (IV):

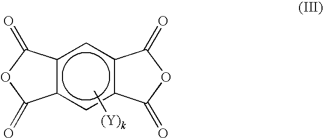

wherein each Y independently represents hydrogen, halogen, —CₐH₂ₐ₊₁ or —C_{b}F_{2b+1}, wherein each of a and b is independently 1, 2, 3 or 4; and k is 1 or 2;

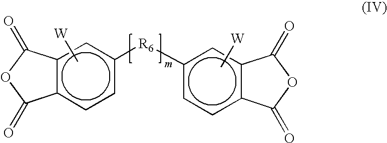

wherein m is 0 or 1, each R₆ independently represents —CH₂—, —O—, —S—, —CO—, —SO₂—, —C(CH₃)₂— or —C(CF₃)₂—, and each W independently represents hydrogen, halogen, —OH, —COOH, —CₐH₂ₐ₊₁ or —C_{b}F_{2b+1}, wherein each of a and b is independently 1, 2, 3 or 4; and
wherein the molar ratio of the total amount of the compound of formula (I) to the total amount of the compound of formula (II) ranges from about 1.0 to about 5.0, and the molar ratio of the total amount of the compound of formula (III) to the total amount of the compound of formula (IV) ranges from about 0.01 to about 2.0.

Another objective of the present invention is to provide a polyimide precursor composition, which comprises the polyimide precursor of the present invention in a solution with a total solid content ranging from about 10% to about 45% by weight.

A further objective of the present invention is to provide a polyimide, which is formed by curing the polyimide precursor composition of the present invention and has a coefficient of thermal expansion ranging from about 16 ppm/° C. to about 18 ppm/° C. after curing.

Yet a further objective of the present invention is to provide a laminate, which comprises a copper foil and a film located on the copper foil and formed by curing the polyimide precursor composition of the present invention, wherein the film is a polyimide film and has a coefficient of thermal expansion ranging from about 16 ppm/° C. to about 18 ppm/° C.

### DESCRIPTION OF THE INVENTION

The polyimide precursor of the present invention is obtained by any suitable polymerization of a diamine monomer and a dianhydride monomer. In general, the species of the diamine monomer useful in the present invention is not restricted by any limitation, and an aromatic diamine is generally used. The diamine monomer useful in the present invention comprises at least one compound of formula (I):

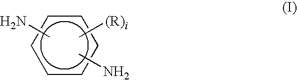

wherein each R independently represents hydrogen, halogen, —CₐH₂ₐ₊₁ or —C_{b}F_{2b+1}, wherein each of a and b is independently 1, 2, 3 or 4, preferably fluorine or methyl; and i is 1, 2, 3 or 4.

The compound of formula (I) for example can be selected from a group consisting of para-phenylenediamine (p-PDA), tetrafluorophenylenediamine (TFPD), 2,5-dimethyl phenylenediamine, 3,5-diamino benzotrifluoride, tetrafluoro-meta-phenylenediamine, meta-phenylenediamine, 2,4-tolyl diamine, 2,5-tolyl diamine, 2,6-tolyl diamine, 2,4-diamino-5-chlorotoluene, 2,4-diamino-6-chlorotoluene and combinations thereof. Preferably, the compound of formula (I) is selected from the following:
para-phenylenediamine (p-PDA)

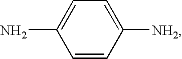

tetrafluorophenylenediamine (TFPD)

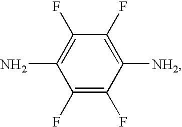

2,5-dimethyl phenylenediamine

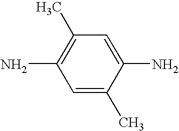

and combinations thereof.

The diamine monomer useful in the present invention also comprises at least one compound of formula (II):

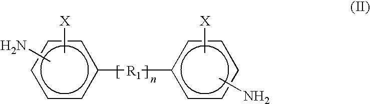

wherein n is 0 or 1; each R₁ independently represents —CH₂—, —O—, —S—, —CO—, —SO₂—, —C(CH₃)₂— or —C(CF₃)₂—, preferably —CH₂— or —O—; and each X independently represents hydrogen, halogen, —OH, —COOH, —CₐH₂ₐ₊₁ or —C_{b}F_{2b+1}, wherein each of a and b is independently 1, 2, 3 or 4, preferably —CₐH₂ₐ₊₁ or —C_{b}F_{2b+1}, wherein each of a and b is independently 1, 2, 3 or 4.

The compound of formula (II) for example can be selected from a group consisting of 4,4′-oxy-dianiline (ODA), meta-dimethyl-para-diaminobiphenyl (DMDB), meta-bis(trifluoromethyl)-para-diaminobiphenyl (TFMB), ortho-dimethyl-para-diaminobiphenyl (oTLD), 3,3′-dichlorobenzidine (DCB), 2,2′-bis(3-aminophenyl)hexafluoropropane, 2,2′-bis(4-aminophenyl)hexafluoropropane, 4,4′-oxo-bis[3-(trifluoromethyl)aniline], 4,4′-methylenebis(o-chloroaniline), 3,3′-sulfonyldianiline, 4,4′-diaminobenzophenone, 4,4′-methylenebis(2-methylaniline), 5,5′-methylenebis(2-aminophenol), 4,4′-oxybis(2-chloroaniline), 4,4′-thiobis(2-methylaniline), 4,4′-thiobis(2-chloroaniline), 4,4′-sulfonylbis(2-methylaniline), 4,4′-sulfonylbis(2-chloroaniline), 5,5′-sulfonylbis(2-aminophenol), 3,3′-dimethyl-4,4′-diaminobenzophenone, 3,3′-dichloro-4,4′-diaminobenzophenone, 4,4′-diaminobiphenyl, 4,4′-methylenedianiline(MDA), 4,4′-thiodianiline, 4,4′-sulfonyldianiline, 4,4′-isopropylidenedianiline, 3,3′-dicarboxybenzidine and combinations thereof. The compound of formula (II) is preferably selected from a group consisting of
4,4′-oxy-dianiline (ODA)

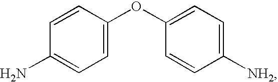

meta-dimethyl-para-diaminobiphenyl (DMDB)

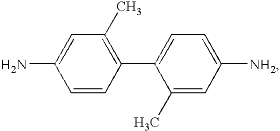

meta-bis(trifluoromethyl)-para-diaminobiphenyl (TFMB)

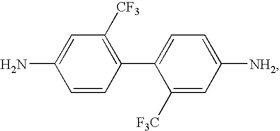

ortho-dimethyl-para-diaminobiphenyl (oTLD)

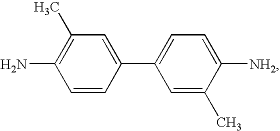

4,4′-methylenedianiline (MDA)

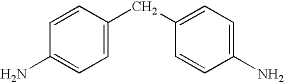

and combinations thereof.

The dianhydride monomer useful in the present invention can generally be aliphatics or aromatics, with aromatic dianhydride preferred. The dianhydride monomer useful in the present invention comprises at least one compound of formula (III):

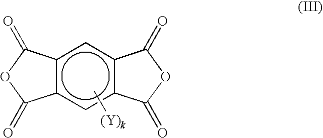

wherein each Y independently represents hydrogen, halogen, —CₐH₂ₐ₊₁ or —C_{b}F_{2b+1}, preferably hydrogen or —C_{b}F_{2b+1}, wherein b is 1, 2, 3 or 4; each of a and b is independently 1, 2, 3 or 4, and k is 1 or 2.

The compound of formula (III) for example is preferably selected from a group consisting of
pyromellitic dianhydride (PMDA)

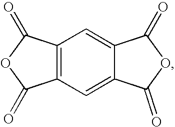

1-(trifluoromethyl)-2,3,5,6-benzene tetracarboxylic dianhydride (P3FDA)

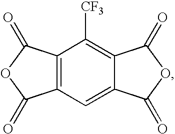

1,4-bis(trifluoromethyl)-2,3,5,6-benzene tetracarboxylic dianhydride (P6FDA)

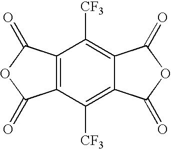

and combinations thereof Pyromellitic dianhydride is most preferred.

The dianhydride monomer useful in the present invention also comprises at least one compound of formula (IV):

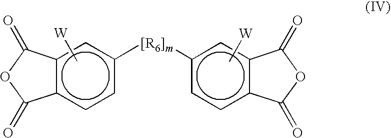

wherein m is 0 or 1; each R₆ independently represents —CH₂—, —O—, —S—, —CO—, —SO₂—, —C(CH₃)₂— or —C(CF₃)₂—, preferably —O—, —CO— or —C(CF₃)₂—; and each W independently represents hydrogen, halogen, —OH, —COOH, —CₐH₂ₐ₊₁ or —C_{b}F_{2b+1}, wherein each of a and b is independently 1, 2, 3 or 4, preferably hydrogen.

The compound of formula (IV) for example can be selected from a group consisting of 4,4′-benzophenone-tetracarboxylic anhydride (BPDA), 4,4′-hexafluoroisopropylidenediphthalic anhydride (6FDA), benzophenonetetracarboxylic dianhydride (BTDA), 4,4′-oxy-diphthalic anhydride (ODPA), 3,3′,4,4′-benzophenonetetracarboxylic dianhydride, 2,2′,3,3′-benzophenonetetracarboxylic dianhydride, 3,3′,4,4′-biphenyltetracarboxylic dianhydride, 2,2′,3,3′-biphenyltetracarboxylic dianhydride, 4,4′-isopropylidenediphthalic anhydride, 3,3′-isopropylidenediphthalic anhydride, 4,4′-oxydiphthalic anhydride, 4,4′-sulfonyldiphthalic anhydride, 3,3′-oxydiphthalic anhydride, 4,4′-methylenediphthalic anhydride, 4,4′-thiodiphthalic anhydride and combinations thereof. The compound of formula (IV) is preferably selected from a group consisting of
4,4′-benzophenone-tetracarboxylic anhydride (BPDA)

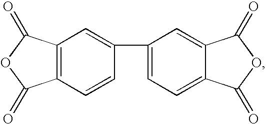

4,4′-hexafluoroisopropylidenediphthalic anhydride(6FDA)

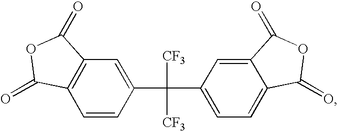

benzophenonetetracarboxylic dianhydride (BTDA)

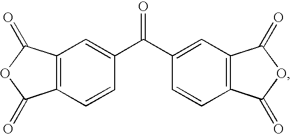

4,4′-oxy-diphthalic anhydride (ODPA)

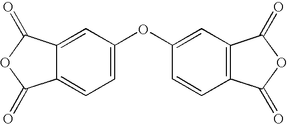

and combinations thereof.

In one embodiment of the polyimide precursor according to the present invention, the precursor is provided through the polymerization of the following compounds:
para-phenylenediamine (p-PDA)

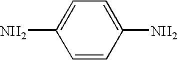

as the compound of formula (I), 4,4′-oxy-dianiline (ODA)

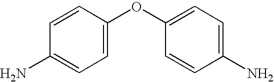

or meta-dimethyl-para-diaminobiphenyl (DMDB)

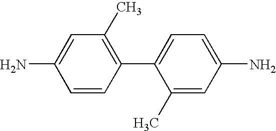

as the compound of formula (II), pyromellitic dianhydride

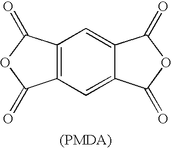

as the compound of formula (III), and 4,4′-benzophenone-tetracarboxylic anhydride (BPDA)

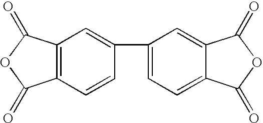

or benzophenonetetracarboxylic dianhydride (BTDA)

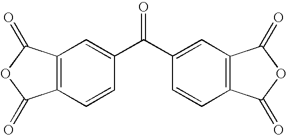

as the compound of formula (IV).

According to the polyimide precursor of the present invention, the ratio of the amount of the compound of formula (I) to the amount of the compound of formula (II) as well as the ratio of the amount of the compound of formula (III) to the amount of the compound of formula (IV) are controlled within a specific range. To achieve better adhesion, the molar ratio of the total amount of the compound of formula (I) to the total amount of the compound of formula (II) ranges from about 1.0 to about 5.0. The molar ratio of the total amount of the compound of formula (III) to the total amount of the compound of formula (IV) ranges from about 0.01 to about 2.0. Preferably, the molar ratio of the total amount of the compound of formula (I) to the total amount of the compound of formula (II) ranges from about 1.0 to about 3.0 and the molar ratio of the total amount of the compound of formula (III) to the total amount of the compound of formula (IV) ranges from about 0.1 to about 1.0. If the molar ratios of the compound of formula (I) to the compound of formula (II) and the compound of formula (III) to the compound of formula (IV) are within the ranges as described above, the coefficient of thermal expansion of the cured polyimide precursor according to the present invention ranges between about 16 ppm/° C. and about 18 ppm/° C.

According to the present invention, to perform the polymerization of a diamine monomer and a dianhydride monomer, the molar ratio of the total amount of the diamine monomer to the total amount of the dianhydride monomer generally ranges from about 0.9 to about 1.

Furthermore, the present invention further provides a polyimide precursor composition, which comprises the polyimide precursor of the present invention, and has a high solid content and contains less solvent. Thus, the soft baking time can be shortened and the soft baking temperature can be lowered to reduce the volume shrinkage caused by the volatilization of the massive solvent. Also, the rate of drying to form a film is fast and the number of coating required to achieve the desired thickness of the product is reduced. The solid content mentioned above generally ranges from about 10% to about 45% by weight, preferably from about 20% to about 45% by weight, based on the weight of the composition.

The useful solvent is not restricted by any limitation, and a polar aprotic solvent is preferred. For example (but not limited thereto), the aprotic solvent can be selected from a group consisting of N,N-dimethylacetamide (DMAc), N-methylpyrrolidone (NMP), N,N-dimethylformamide (DMF), tetramethylurea (TMU), dimethylsulfoxide (DMSO) and combinations thereof. N,N-dimethylacetamide (DMAc) is preferred.

Depending on the practical application conditions, the polyimide precursor composition of the present invention can optionally contain a further additive known by a person skilled in the art, such as a silane coupling agent, a leveling agent, a stabilizer, a catalyst and/or a defoaming agent and the like.

According to one preferred embodiment of the present invention, the polyimide precursor composition comprises para-phenylenediamine (p-PDA), 4,4′-oxy-dianiline (ODA), pyromellitic dianhydride (PMDA) and 4,4′-benzophenone-tetracarboxylic anhydride (BPDA). When the molar ratio of the total amount of para-phenylenediamine (p-PDA) to the total amount of 4,4′-oxy-dianiline (ODA) ranges from about 1.0 to about 5.0 in combination with the molar ratio of the total amount of pyromellitic dianhydride (PMDA) to the total amount of 4,4′-benzophenone-tetracarboxylic anhydride (BPDA) ranges from about 0.01 to about 2.0, its polyimide precursor composition is cured to prepare a polyimide polymer with a coefficient of thermal expansion ranging from about 16 ppm/° C. to about 18 ppm/° C. The aforesaid range of the coefficient of thermal expansion is close to the coefficient of thermal expansion of 17 ppm/° C. that copper foil has. Also, the polyimide polymer exhibits good adhesion to the surface of the copper foil.

The present invention also provides a polyimide, which is formed by curing the polyimide precursor composition of the present invention and has a coefficient of thermal expansion ranging from about 16 ppm/° C. to about 18 ppm/° C. The curing can generally be achieved by heat treatment. Multi-stage baking in an inert gas environment (e.g., nitrogen gas) is preferred. For example, the solvent in the polyimide precursor composition is first removed by the slow evaporation at a low temperature (i.e., soft baking step), then the temperature is gradually increased to form a polyimide by imidization (curing). With this method, warping deformation due to a sudden change of the stress of the polyimide caused by rapid heating can be prevented.

The present invention further provides a laminate useful for producing a flexible printed circuit board. The laminate of the present invention comprises a copper foil and a film located on the copper foil and formed by curing the polyimide precursor composition of the present invention. The film is a polyimide film and has a coefficient of thermal expansion ranging from about 16 ppm/° C. to about 18 ppm/° C. The laminate of the present invention does not use an adhesive for binding the polyimide film and the copper foil, and is classified as an adhesiveless copper clad laminate. The film has a coefficient of thermal expansion close to that of the copper foil, and exhibits good dimensional stability and excellent adhesion effect to the copper foil. The laminate of the present invention exhibits a dimensional stability of less than about 0.050% as measured in accordance with IPC-TM-650(2.2.4) standard method; and exhibits a peeling strength of not less than about 0.8 kgf/cm as measured in accordance with IPC-TM-650(2.4.9) standard method. As a result, the laminate of the present invention has high applicability.

Any copper foil suitable for a printed circuit board can be used in the laminate of the present invention, and an appropriate copper foil can be selected depending on the costs and the functionality of final products. For example, the copper foil suitable for the present invention can be selected from a group consisting of a rolled annealed copper foil (Ra copper foil), an electrodeposited copper foil (ED copper foil), a high temperature elongation electrodeposited copper foil (HTE electrodeposited copper foil) and combinations thereof. The rolled annealed copper foil has advantages, such as high elongation, excellent flexural endurance, few surface defects on matt copper, fine grains, low surface roughness and high strength. Although the price of the rolled annealed copper foil is much more expansive than the electrodeposited copper foil, the rolled annealed copper foil is suitable for the printed circuit board with high density thinning and high reliability.

The polyimide laminate for producing a flexible printed circuit board of the present invention can be prepared according to any method known by a person skilled in the art. For example, in the case of monomers of para-phenylenediamine (pPDA), 4,4′-oxy-dianiline (ODA), pyromellitic dianhydride (PMDA), and 4,4′-benzophenone-tetracarboxylic anhydride (BPDA), the polyimide laminate can be prepared using a method comprising the following steps:
(1) Pyromellitic dianhydride (PMDA) monomer is dissolved in a solvent, and then an organic alcohol is added for reaction to obtain an dianhydride monomer bearing the organic alcohol as an end group. The organic alcohol is selected from a compound bearing a hydroxyl group, generally from an alcohol such as a monol, a diol or a polyol. Preferably, the organic alcohol is selected from a monol, with the chemical formula ROH, wherein R represents C₁-C₁₄ alkyl, C₆-C₁₄ aryl, aralkyl or ethylenically unsaturated group;
(2) Para-phenylenediamine (PPDA) monomer, 4,4′-oxy-dianiline (ODA) monomer and 4,4′-benzophenone-tetracarboxylic anhydride (BPDA) are sequentially added to the mixture of step (1), followed by copolymerization to prepare a polyamic acid solution with a solid content ranging from about 10% to about 45% by weight (i.e., the polyimide precursor composition); and
(3) The polyimide precursor composition obtained in step (2) is coated on a copper foil substrate. With curing in multi-stage heating, a polyimide film laminate according to the present invention is obtained.
   The method of coating a polyimide precursor composition on a copper foil is the coating method known by a person skilled in the art, which comprises, for example, double-layer extrusion coating, roller coating, micro gravure coating, flow coating, dip coating, spray coating, spin coating, curtain coating and the like. Double-layer extrusion coating is preferred.

In step (3) as described above, the temperature is controlled in a range from about 200° C. to about 400° C., and the curing time is about 450 minutes to about 600 minutes.

### EXAMPLES

### Testing Method

The dimensional stability measurement was performed in accordance with IPC-TM-650(2.2.4) method using a two-dimensional precision measuring table (X-Y table) to measure the dimensional variation of the polyimide laminate before and after it was treated under different temperature changes. The testing conditions set in the following Examples were at 80° C. and 150° C.

The peeling strength measurement was performed in accordance with IPC-TM-650(2.4.9) method using an universal tensometer to measure the 90° peeling strength between the polyimide and the copper foil.

The tensile strength and elongation measurements were performed in accordance with IPC-TM-650(2.4.19) method using an universal tensometer to measure the mechanical property of the polyimide laminate.

The glass transition temperature and the coefficient of thermal expansion were measured in accordance with IPC-TM-650(2.4.24) method using an thermomechanical analyzer (TMA) to measure the difference of the coefficient of thermal expansion between the polyimide laminate and the copper foil.

### Example 1

14.48 g of pyromellitic dianhydride (PMDA) was put into an 1-liter reactor with N,N-dimethylacetamide (DMAc) as a solvent and stirred under nitrogen gas. After heated to 50° C., 0.54 g of absolute alcohol was added to conduct the reaction for 1 hour to completion. After the temperature was cooled to room temperature, 51.69 g of para-phenylenediamine (PPDA) and 37.22 g of 4,4′-oxy-dianiline (ODA) were added to conduct the reaction for 1 hour. Lastly, 175.80 g of 4,4′-benzophenone-tetracarboxylic anhydride (BPDA) was added and then stirred for 5 hours. A high solid content solution of polyamic acid with a composition of 28% by weight in solid content was obtained. The amount of each component is listed in Table 1.

The resulting polyamic acid solution was uniformly coated on the surface of a copper foil and then processed through the multi-stage drying process as described below to obtain an adhesiveless polyimide laminate:
(1) The temperature was raised from room temperature to 60° C. within 30 minutes, and maintained at 60° C. for 30 minutes;
(2) The temperature was raised from 60° C. to 150° C. within 90 minutes, and maintained at 150° C. for 30 minutes;
(3) The temperature was raised from 150° C. to 250° C. within 100 minutes, and maintained at 250° C. for 30 minutes;
(4) The temperature was raised from 250° C. to 350° C. within 100 minutes, and maintained at 350° C. for 120 minutes; and
(5) The temperature was cooled from 350° C. to room temperature within 4 hours.

The appearance of the resulting polyimide laminate was flat, exhibiting no curling on the edge, even after etching test. The peeling strength, dimensional stability, tensile strength, glass transition temperature and coefficient of thermal expansion of the polyimide laminate were measured in accordance with the testing method as mentioned above, and the results are listed in Table 2.

### Examples 2 to 8

The procedure and method described in Example 1 were repeated, except that the proportions of the components listed in Table 1 were used. The physical properties of the resulting polyimide laminate are listed in Table 2 as well.

### Comparative Examples A to D

The procedure and method described in Example 1 were repeated, except that the proportions of the components listed in Table 1 were used. The physical properties of the resulting polyimide laminate are listed in Table 2 as well.

TABLE 1

| | | Compound | | | Compound | Compound | | Compound | Compound | |
|---|---|---|---|---|---|---|---|---|---|---|
| | | of | Compound of | | of | of | | of formula | of formula | |
| | | formula(III) | formula (IV) | | formula (I) | formula (II) | | (III)/ | (I)/ | Solid |
| | | PMDA | BPDA | BTDA | pPDA | ODA | DMDB | Compound | Compound | content |
| | DMAc | grams | grams | grams | grams | grams | grams | of formula | of formula | % by |
| Examples | grams | (mmole) | (mmole) | (mmole) | (mmole) | (mmole) | (mmole) | (IV) | (II) | weight |
| 1 | 720 | 14.48 | 175.80 | | 51.69 | 37.22 | | 0.1/0.9 | 0.72/0.28 | 28% |
| | | (66.4) | (597.5) | | (478.0) | (185.9) | | | | |
| 2 | | 13.50 | | 179.49 | 46.85 | | 39.42 | 0.1/0.9 | 0.70/0.30 | |
| | | (61.9) | | (557.0) | (433.2) | | (185.7) | | | |
| 3 | | 29.36 | 158.44 | | 50.95 | 40.44 | | 0.2/0.8 | 0.70/0.30 | |
| | | (134.6) | (538.5) | | (471.2) | (201.9) | | | | |
| 4 | | 27.51 | | 162.54 | 46.37 | | 42.83 | 0.2/0.8 | 0.68/0.32 | |
| | | (126.1) | | (504.4) | (428.8) | | (201.7) | | | |
| 5 | | 44.67 | 140.58 | | 50.19 | 43.74 | | 0.3/0.7 | 0.68/0.32 | |
| | | (204.8) | (477.8) | | (464.2) | (218.4) | | | | |
| 6 | | 41.95 | | 144.59 | 45.06 | | 47.63 | 0.3/0.7 | 0.65/0.35 | |
| | | (192.3) | | (448.7) | (416.7) | | (224.3) | | | |
| 7 | | 76.25 | 102.85 | | 46.87 | 53.20 | | 0.5/0.5 | 0.62/0.38 | |
| | | (349.6) | (349.6) | | (433.4) | (265.8) | | | | |
| 8 | | 72.50 | | 107.11 | 43.14 | | 56.45 | 0.5/0.5 | 0.60/0.40 | |
| | | (332.4) | | (332.4) | (398.9) | | (265.9) | | | |
| A | | 126.29 | 42.59 | | 40.70 | 69.56 | | 0.8/0.2 | 0.52/0.48 | |
| | | (579.0) | (144.7) | | (376.3) | (347.4) | | | | |
| B | | 121.41 | | 44.84 | 36.11 | | 76.81 | 0.8/0.2 | 0.48/0.52 | |
| | | (556.6) | | (139.2) | (334.0) | | (361.8) | | | |
| C | | 28.00 | 151.08 | | 33.32 | 66.83 | | 0.2/0.8 | 0.48/0.52 | |
| | | (128.4) | (513.5) | | (308.1) | (333.8) | | | | |
| D | | 26.27 | | 155.3 | 31.26 | | 66.49 | 0.2/0.8 | 0.48/0.52 | |
| | | (120.5) | | (481.8) | (289.1) | | (313.2) | | | |

TABLE 2

| | | | Glass | | | |
|---|---|---|---|---|---|---|
| | Appearance of the | Coefficient of | transition | | | |
| | polyimide copper | thermal expansion | temperature | Dimensional | Peeling strength | Tensile strength |
| Examples | clad laminate | ppm/° C. | ° C. | stability % | kgf/cm | MPa |
| 1 | Flat | 17.5 | 355 | 0.024 | 1.02 | 217 |
| 2 | Flat | 17.8 | 343 | 0.031 | 1.21 | 225 |
| 3 | Flat | 17.6 | 366 | 0.008 | 1.13 | 208 |
| 4 | Flat | 17.1 | 345 | 0.012 | 1.06 | 211 |
| 5 | Flat | 16.9 | 361 | 0.019 | 0.91 | 196 |
| 6 | Flat | 17.4 | 337 | 0.014 | 0.94 | 215 |
| 7 | Flat | 17.7 | 351 | 0.033 | 0.86 | 187 |
| 8 | Flat | 17.4 | 331 | 0.028 | 0.83 | 194 |
| A | Flat | 17.4 | 349 | 0.042 | 0.73 | 176 |
| B | Flat | 17.9 | 328 | 0.035 | 0.57 | 168 |
| C | Warping | 25.1 | 345 | 0.083 | 0.73 | 196 |
| D | Warping | 25.7 | 320 | 0.072 | 0.81 | 203 |

It can be known from Table 1 and Table 2 that the polyimide laminate according to the present invention not only has a coefficient of thermal expansion close to that of a copper foil, but also exhibits good peeling strength and tensile strength.

1. A polyimide precursor that is obtained by the polymerization of a diamine monomer and a dianhydride monomer, wherein the diamine monomer comprises at least one compound of formula (I) and at least one compound of formula (II): 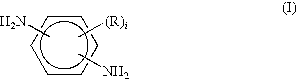
wherein each R independently represents hydrogen, halogen, —CₐH₂ₐ₊₁ or —C_{b}F_{2b+1}, wherein each of a and b is independently 1, 2, 3 or 4, and i is 1, 2, 3 or 4; 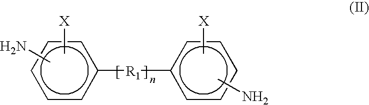
wherein n is 0 or 1, each R, independently represents —CH₂—, —O—, —S—, —CO—, —SO₂—, —C(CH₃)₂— or —C(CF₃)₂—, and each X independently represents hydrogen, halogen, —OH, —COOH, —CₐH₂ₐ₊₁ or —C_{b}F_{2b+1}, wherein each of a and b is independently 1, 2, 3 or 4; the dianhydride monomer comprises at least one compound of formula (III) and at least one compound of formula (IV): 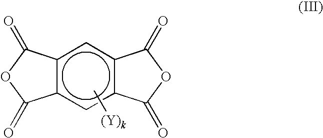
wherein each Y independently represents hydrogen, halogen, —CₐH₂ₐ₊₁ or —C_{b}F_{2b+1}, wherein each of a and b is independently 1, 2, 3 or 4, and k is 1 or 2; 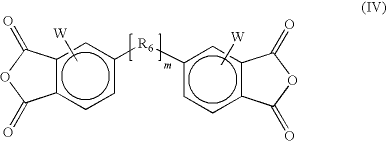
wherein m is 0 or 1, each R₆ independently represents —CH₂—, —O—, —S—, —CO—, —SO₂—, —C(CH₃)₂— or —C(CF₃)₂—, and each W independently represents hydrogen, halogen, —OH, —COOH, —CₐH₂ₐ₊₁ or —C_{b}F_{2b+1}, wherein each of a and b is independently 1, 2, 3 or 4; and wherein, the molar ratio of the total amount of the compound of formula (I) to the total amount of the compound of formula (II) ranges from about 1.0 to about 5.0, and the molar ratio of the total amount of the compound of formula (III) to the total amount of the compound of formula (IV) ranges from about 0.01 to about 2.0.

2. The polyimide precursor of claim 1, wherein the molar ratio of the total amount of the compound of formula (I) to the total amount of the compound of formula (II) ranges from about 1.0 to about 3.0.

3. The polyimide precursor of claim 1, wherein the compound of formula (I) is selected from a group consisting of: 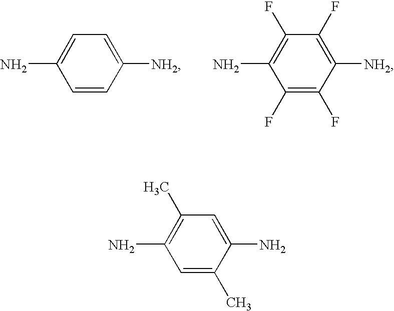
and combinations thereof.

4. The polyimide precursor of claim 1, wherein the compound of formula (II) is selected from a group consisting of: 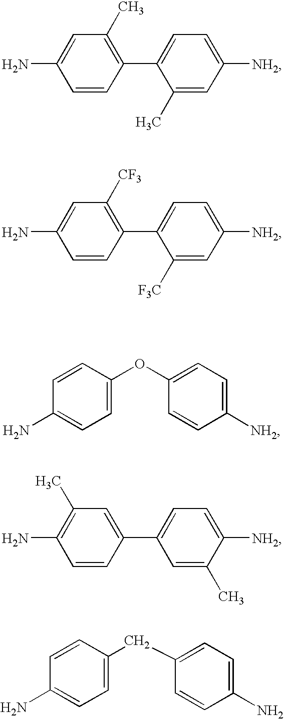
and combinations thereof.

5. The polyimide precursor of claim 1, wherein the compound of formula (III) is selected from a group consisting of: 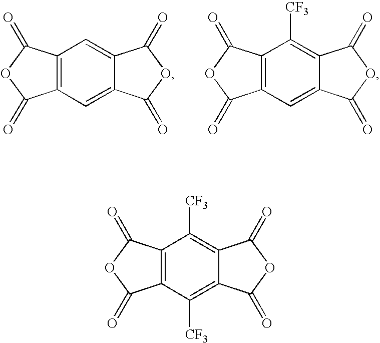
and combinations thereof.

6. The polyimide precursor of claim 1, wherein the compound of formula (IV) is selected from a group consisting of: 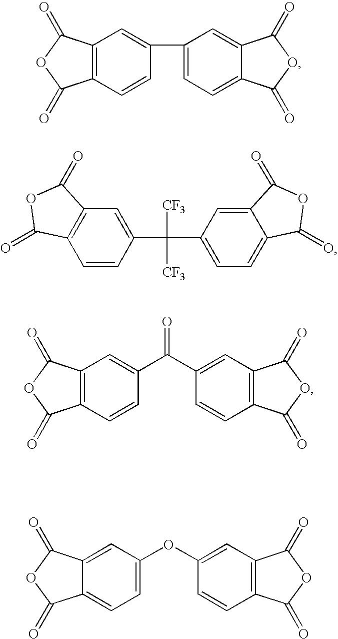
and combinations thereof.

7. The polyimide precursor of claim 1, wherein the diamine monomer comprises para-phenylenediamine and 4,4′-oxy-dianiline, and the dianhydride monomer comprises pyromellitic dianhydride and 3,3′4,4′-biphenyltetracarboxylic dianhydride.

8. The polyimide precursor of claim 1, wherein the molar ratio of the total amount of the diamine monomer to the total amount of the dianhydride monomer ranges from about 0.9 to about 1.

9. A polyimide precursor composition, which comprises the polyimide precursor of claim 1 in a solution with a total solid content ranging from about 10% to about 45% by weight.

10. The polyimide precursor composition of claim 9, further comprising a polar aprotic solvent.

11. A polyimide, which is formed by curing the polyimide precursor composition of claim 9 and has a coefficient of thermal expansion ranging from about 16 ppm/° C. to about 18 ppm/° C.

12. A laminate, which comprises a copper foil and a film located on the copper foil and formed by curing the polyimide precursor composition of claim 9, wherein the film is a polyimide film and has a coefficient of thermal expansion ranging from about 16 ppm/° C. to about 18 ppm/° C.

13. The laminate of claim 12, wherein the copper foil is selected from a group consisting of rolled annealed copper foil, electrodeposited copper foil, high temperature elongation electrodeposited copper foil and combinations thereof.

14. The laminate of claim 12, which exhibits a dimensional stability of less than about 0.050% as measured in accordance with IPC-TM-650(2.2.4) standard method.

15. The laminate of claim 12, which exhibits a peeling strength of not less than about 0.8 kgf/cm as measured in accordance with IPC-TM-650(2.4.9) standard method.

16. The laminate of claim 12, wherein the film is formed through a coating method by applying coating of the polyimide precursor composition on the surface of the copper foil, wherein the coating method is selected from a group consisting of roller coating, micro gravure coating, flow coating, dip coating, spray coating, spin coating, curtain coating, double-layer extrusion coating and combinations thereof.
